(19) United States
(12) Patent Application Publication
(10) Pub. No.: US 2026/0350772 A1
(43) Pub. Date: Nov. 5, 2026

(54) DYNAMIC FOURIER FILTER FOR DEFECT INSPECTION

(71) Applicant: Applied Materials, Inc., Santa Clara, CA (US)

(72) Inventors: Shifang Li, Pleasanton, CA (US); Keith Buckley Wells, Santa Cruz, CA (US); Thomas L. Laidig, Richmond, CA (US); Ulrich Mueller, Berkeley, CA (US); Hanyou Chu, Palo Alto, CA (US)

(21) Appl. No.: 19/199,187

(22) Filed: May 5, 2025

(51) Int. Cl. G06T 7/00; G01N 21/88; G06F 11/07; G06V 10/143; G06V 10/147

(52) U.S. Cl. CPC G06T 7/0004; G01N 21/8851; G06F 11/0736; G06F 11/0793; G06V 10/143; G06V 10/147; G01N 2021/8864; G01N 2021/8887; G06T 2207/20081

(57) ABSTRACT

A method includes identifying first pattern data associated with a first substrate surface processed via a substrate processing system. The method further includes causing, based on the first pattern data, a first subset of various portions of an optical modulator positioned at a pupil plane of an optical system to be in a first configuration. The first configuration provides first portions of light reflected from the first substrate surface to an image detector. The method further includes causing, based on the first pattern data, a second subset of the various portions of the optical modulator to be in a second configuration. The second configuration prevents second portions of light reflected from the first substrate surfaces from contacting the image detector. The method further includes performance of a corrective action associated with the substrate processing system based on the first portion of light provided through the first subset.

### TECHNICAL FIELD

The present disclosure relates to defect inspection, and in particular to a dynamic Fourier filter for defect inspection.

### BACKGROUND

Products are produced by performing one or more manufacturing processes using manufacturing equipment. These products are inspected to check for any defects that arose during the manufacturing process. For example, a substrate can be inspected during the substrate manufacturing process to check for any defects that may impact substrate performance.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method includes identifying first pattern data associated with a first substrate surface processed via a substrate processing system. The method further includes causing, based on the first pattern data, a first subset of various portions of an optical modulator positioned at a pupil plane of an optical system to be in a first configuration. The first configuration provides first portions of light reflected from the first substrate surface to an image detector. The method further includes causing, based on the first pattern data, a second subset of the various portions of the optical modulator to be in a second configuration. The second configuration prevents second portions of light reflected from the first substrate surfaces from contacting the image detector. The method further includes performance of a corrective action associated with the substrate processing system based on the first portion of light provided through the first subset.

In another aspect of the disclosure, a non-transitory machine-readable storage medium storing instruction causes, when executed, a processing device to perform operations including identifying first pattern data associated with a first substrate surface processed via a substrate processing system. The operations further include causing, based on the first pattern data, a first subset of various portions of an optical modulator positioned at a pupil plane of an optical system to be in a first configuration. The first configuration provides first portions of light reflected from the first substrate surface to an image detector. The operations further include causing, based on the first pattern data, a second subset of the various portions of the optical modulator to be in a second configuration. The second configuration prevents second portions of light reflected from the first substrate surfaces from contacting the image detector. The operations further include performance of a corrective action associated with the substrate processing system based on the first portion of light provided through the first subset.

In another aspect of the disclosure, a system includes memory and a processing device coupled to the memory. The processing device is to identify first pattern data associated with a first substrate surface processed via a substrate processing system. The processing device is further to cause, based on the first pattern data, a first subset of various portions of an optical modulator positioned at a pupil plane of an optical system to be in a first configuration. The first configuration provides first portions of light reflected from the first substrate surface to an image detector. The processing device is further to cause, based on the first pattern data, a second subset of the various portions of the optical modulator to be in a second configuration. The second configuration prevents second portions of light reflected from the first substrate surfaces from contacting the image detector. The processing device is further to perform a corrective action associated with the substrate processing system based on the first portion of light provided through the first subset.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1A is a schematic block diagram of an inspection system including a dynamic Fourier filter, according to some embodiments.

FIG. 1B is a block diagram illustrating a system architecture, according to some embodiments.

FIGS. 2A-C illustrate inspection systems including an optical modulator, according to some embodiments.

FIGS. 3A-B are block diagrams illustrating machine learning models associated with defect inspection, according to some embodiments.

FIGS. 4A-D are flow diagrams of methods associated with defect inspection, according to certain embodiments.

FIG. 5 is a block diagram illustrating an example computer system, according to some embodiments.

### DETAILED DESCRIPTION OF EMBODIMENTS

Described herein are technologies directed to a dynamic filter for defect inspection (e.g., dark field defect inspection using a Fourier filter to dynamically generate patterns in a die).

Products are produced by performing one or more manufacturing processes using manufacturing equipment. These products are inspected to check for any defects that arose during the manufacturing process. For example, a substrate (e.g., wafer, semiconductor, display, etc.) can be inspected during the substrate manufacturing process to check for any defects that may impact substrate performance. A substrate processing system is used to process substrates and may include processing chambers that each perform substrate processing operations. Substrates may be inspected for defects following and/or during the substrate processing operations.

A Fourier filter may be used to inspect substrates for defects. A Fourier filter is a type of optical filter used to filter out specific intensities (e.g., patterns, brightnesses). Conventionally, this is accomplished by placing a mask or spatial filter at a plane (e.g., the Fourier plane) of a lens system to selectively block or enhance certain intensities, such as suppressing brighter portions of etching patterns of a substrate that correspond to a desired and/or intended pattern, which is not of interest for improving sensitivity to dimmer portions (e.g., features) that correspond to defects of the substrate. This type of filtering may be implemented in identifying defects in substrates by blocking the pattern emitted by the substrate itself, allowing only the pattern emitted by the defects to pass through the optical system (e.g., lens).

Conventionally, the mask or spatial filter used is static (e.g., based on a known etching pattern on a substrate). If the etching pattern on a substrate changes, a new mask is needed to block the substrate pattern noise and allow the defect pattern through to identify the defects on the substrate. Because the etching pattern on a substrate can change anytime a different type of circuitry is designed, conventional solutions implement multiple masks that are manually switched out to match the new etching pattern. This leads to many masks being made, each needed to be properly stored and maintained. Switching out the mask each time the etching pattern changes and creating new masks for new etching patterns leads to delays in processing and inspection times, reduction in yield, unplanned downtime, unscheduled replacement and maintenance of the filter and masks, etc. Manually switching out masks and generating new masks also leads to user error, unidentified substrate defects, less optimal manufacturing parameters, damage to equipment, etc. Additionally, different areas of a substrate may have different etching patterns. Conventional filters and/or filtering methods are unable to adjust or update their patterns quickly enough to accommodate these different etching patterns when scanning over and/or inspecting the substrate. This limitation may lead to over-filtering in one area of the substrate and/or under-filtering in another area of the substrate.

The devices, systems, and methods disclosed herein provide solutions to these and other shortcomings of conventional systems.

In some embodiments, a processing device identifies first pattern data associated with a first substrate surface processed via a substrate processing system. In some embodiments, to identify the first pattern data, the processing device identifies image data associated with the first substrate surface and determines, based on the image data, a first portion of the first substrate surface (e.g., defect of the first substrate surface) that corresponds to the first portions of light, and determines, based on the image data, a second portion of the first substrate surface corresponding to the second portions of light.

The processing device causes, based on the first pattern data, a first subset of an optical modulator positioned at a pupil plane of an optical system to be in a first configuration to provide first portions of light reflected from the first substrate surface to an image detector. An optical system may include various lenses, mirrors, and/or apertures arranged to control, direct, and/or manipulate light for imaging, measurement, and/or illumination purposes. In some embodiments, an inspection system and/or inspection equipment is an optical system that includes the image detector, the optical modulator, and/or a lens.

The processing device also causes, based on the first pattern data, a second subset of the optical modulator to be in a second configuration to prevent second portions of light reflected from the first substrate surface from contacting the image detector.

In some embodiments, the optical modulator is a microelectromechanical system (MEMS) digital micromirror device (DMD), each of the portions of the optical modulator is a micromirror, the first configuration corresponds to a first micromirror angle that causes the first portions of light to be directed to the image detector, and the second configuration corresponds to a second micromirror angle that causes the second portions of light to be directed somewhere different than the image detector.

In some embodiments, the optical modulator is a liquid crystal display (LCD), each of the portions of the optical modulator includes a pixel of the LCD, the first configuration corresponds to a first pixel configuration that allows light transmission via the pixel, and the second configuration corresponds to a second pixel configuration that prevents the light transmission via the pixel.

The processing device causes a corrective action associated with the substrate processing system based on the first portions of light provided through the first subset. The processing device may determine image data (e.g., of the substrate surface) based on the first portions of light and then cause performance of the corrective action based on the image data.

Aspects of the present disclosure result in technical advantages over conventional solutions. The present disclosure reduces the risk of failures and unplanned downtime compared to conventional systems. The present disclosure allows for the filter to update in response to a new etch pattern in real time, which reduces the amount of time needed to complete the inspection of the substrate and the overall substrate processing time compared to conventional solutions. The present disclosure dynamically changes responsive to a new etch pattern, reducing the amount of masks or filters needed from one per etch design to a single filter compared to conventional solutions. The present disclosure reduces inspection time compared to conventional solutions by implementing a single filter that does not need to be manually changed with each etch design. This allows for the present disclosure to have less substrate defects by increasing the detection sensitivity to these defects, increased yield, reduced unplanned downtime, reduced unscheduled replacement and maintenance of the filter, etc. than conventional systems.

Although some embodiments of the present disclosure are described with respect to using an optical modulator that is a MEMS DMD or an LCD, in some embodiments, a different type of optical modulator may be used. While some embodiments of the present disclosure are directed to an inspection system, the components of the inspection system may be incorporated into other systems, such as a metrology system, a semiconductor processing system, etc. Some aspects of the present disclosure are directed to defect inspection of a substrate but may be applied to other types of inspection or similar processes for other types of materials.

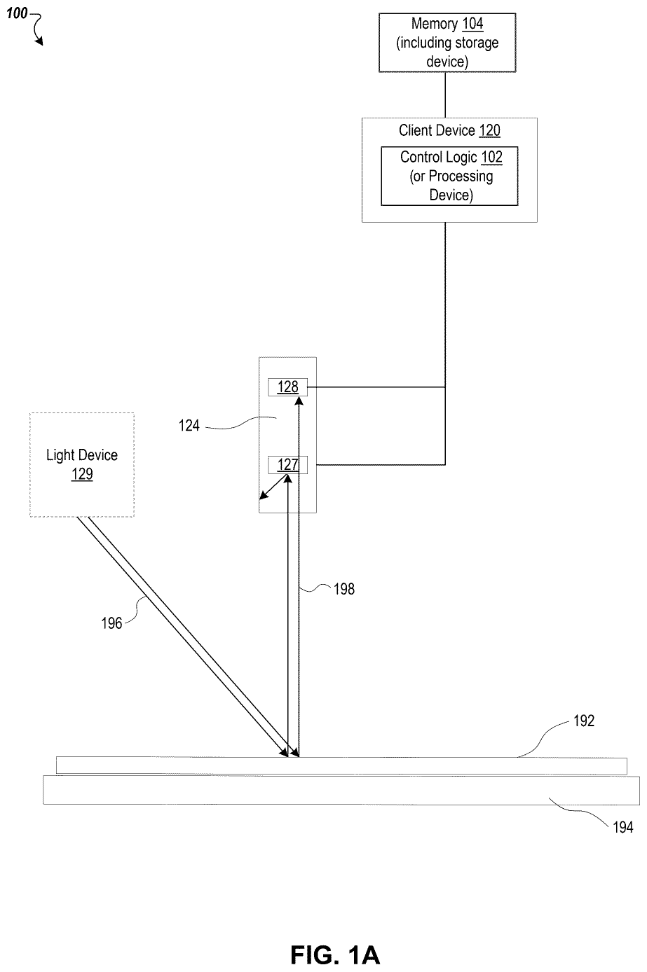

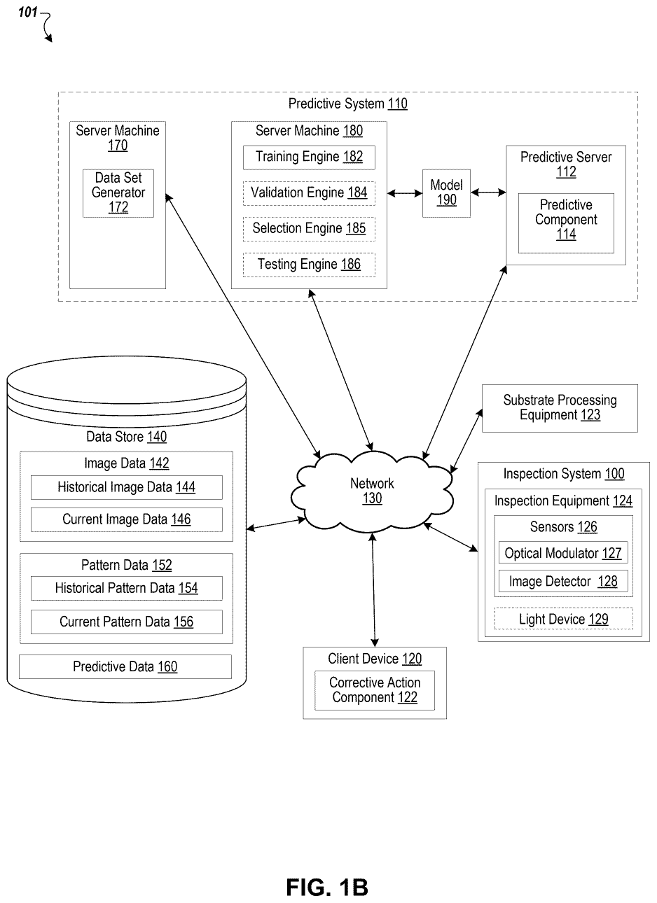

FIG. 1A is a schematic block diagram of an inspection system 100 including an optical modulator 127 (e.g., a dynamic Fourier filter), according to some embodiments. In some embodiments, the inspection system 100 includes a substrate support 194 that receives a substrate 192, inspection equipment 124, and a client device 120. The client device 120 may include control logic 102 (e.g., executed by a processing device). The client device 120 (e.g., via control logic 102, via processing device) may be configured to execute instructions or otherwise control the inspection equipment 124, as will be described in detail. In some embodiments, the inspection system 100 includes memory 104 coupled to a processing device (e.g., that executes the control logic 102. In some embodiments, the memory 104 is part of client device 120. In some embodiments, memory 104 is separate from client device. The memory can include volatile memory and optionally also non-volatile memory, such as a storage device. For example, the memory 104 can be a non-transitory machine-readable storage medium storing instructions, which when executed by the processing device (e.g., of client device 120), causes the processing device to perform particular operations that will be discussed herein.

The inspection equipment 124 may be an optical system that includes an optical modulator 127 configured to permit and/or block light 196 and/or reflected light 198 from traveling to an image detector 128. The light 196 may originate from a light device 129 and may be reflected by the substrate 192 as reflected light 198 toward the optical modulator 127 and/or the image detector 128. The light device 129 may be integral to the inspection equipment 124 or may be a separate device configured to provide light 196 for use by the inspection equipment 124. In some embodiments, the optical modulator 127 and/or the image detector 128 are coupled to the client device 120 such that the optical modulator 127 and/or the image detector 128 perform particular operations that will be discussed herein responsive to instructions received from the client device 120.

The optical modulator 127 of the inspection equipment 124 may be a filter (e.g., a Fourier filter) configured to selectively transmit, absorb, reflect, and/or modify specific intensities (e.g., brightness) of light (e.g., the reflected light 198). The optical modulator 127 may include a MEMS DMD, a LCD, a mirror device, and/or the like. In some embodiments, the optical modulator 127 reduces optical noise (e.g., by suppressing bright features from the substrate that are of little or no interest because the bright features correspond to intended and/or desired features on the substrate), which is unwanted variations or distortions in an optical signal caused by factors such as scattering, diffraction, ambient light interference, and/or imperfections that can degrade the image quality and/or signal accuracy of the optical system. The optical modulator 127 may selectively allow certain intensities (e.g., intensities associated with defects in the substrate 192) of the reflected light 198 to pass to the image detector 128 of the inspection equipment 124, while selectively blocking other intensities (e.g., intensities associated with the expected etching pattern of the substrate 192, intensities associated with substantially non-defective portions of the substrate 192) of the reflected light 198 from reaching the image detector 128.

The image detector 128 may be a sensor configured to receive the reflected light 198 from (e.g., that passes through, that is directed by) the optical modulator 127. In some embodiments, the image detector 128 captures (e.g., detects, receives, etc.) the reflected light 198 and converts the reflected light 198 into image data for processing, displaying, and/or analyzing. In some embodiments, the image data is processed by the control logic 102 of the client device 120 and may be used to adjust the optical modulator 127 (e.g., adjust to accommodate periodic features on the substrate that are known to not be associated with a defect; alternatively, refine which intensities of the reflected light 198 are allowed by the optical modulator 127 to arrive at the image detector 128 and which are prevented by the optical modulator 127 from arriving at the image detector 128). In some embodiments, the image data is used to cause performance of a corrective action.

In some embodiments, the portions (e.g., intensities) of the reflected light 198 that are provided by (e.g., permitted to pass through, directed by) the optical modulator 127 to the image detector 128 include (e.g., constitute) a first pattern. The first pattern may be associated with defects in the substrate 192 and/or defects in an etching pattern of the substrate 192. In some embodiments, the intensities of the reflected light 198 that are prevented from arriving at the image detector 128 by the optical modulator 127 include (e.g., constitute) a second pattern. The second pattern may be associated with one or more portions of the substrate without defects (e.g., a standard substrate, a substantially ideal substrate, a substantially properly manufactured substrate, portions of the substrate that meet threshold property values, etc.) and/or an etched substrate without etching defects (e.g., an expected etching pattern, a substantially defect-free etching pattern, a substantially ideal etching pattern, etc.). In some embodiments, the optical modulator 127 may filter (e.g., remove, block) the reflected light 198 associated with portions of a substrate that meet threshold conditions (e.g., threshold property values) and/or expected etching pattern (e.g., the first pattern), allowing the reflected light 198 associated with non-standard portions of a substrate (e.g., portions of a substrate that do not meet threshold conditions, do not meet threshold property values, etc.) and/or a defective etching pattern (e.g., the second pattern) to reach the image detector 128. The second pattern may be interpreted (e.g., by the image detector 128, by a processing device, etc.) as image data associated with a defect of the substrate 192 and/or a defect in the etching pattern of the substrate 192.

FIG. 1B is a block diagram illustrating a system architecture 101 (e.g., system) including the inspection system 100, according to some embodiments. The system 101 includes the inspection system 100, a client device 120, substrate processing equipment 123, a predictive server 112, and a data store 140. In some embodiments, the predictive server 112 is part of a predictive system 110. In some embodiments, the predictive system 110 further includes server machines 170 and 180. In some embodiments, the inspection system 100 includes inspection equipment 124 (e.g., sensors 126) and the light device 129. In some embodiments, the light device 129 is part of the inspection equipment 124. In some embodiments, the light device 129 is separate from the inspection equipment 124. In some embodiments, client device includes corrective action component 122 (e.g., control logic 102 of FIG. 1A.).

In some embodiments, one or more of the client devices 120, substrate processing equipment 123, inspection system 100, sensors 126, predictive server 112, data store 140, server machine 170, and/or server machine 180 are coupled to each other via a network 130 for generating predictive data 160 for substrate defect detection (e.g., to perform a corrective action). In some embodiments, network 130 is a public network that provides the client device 120 with access to the predictive server 112, data store 140, and other publicly available computing devices. In some embodiments, network 130 is a private network that provides client device 120 access to the inspection system 100, substrate processing equipment 123, the sensors 126, the data store 140, and other privately available computing devices. In some embodiments, network 130 includes one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, the client device 120 includes a computing device such as a Personal Computer (PC), laptop, mobile phone, smart phone, tablet computer, netbook computer, etc. In some embodiments, the client device 120 includes a corrective action component 122. In some embodiments, the corrective action component 122 may also be included in the predictive system 110 (e.g., machine learning processing system). In some embodiments, the corrective action component 122 is alternatively included in the predictive system 110 (e.g., instead of being included in client device 120). Client device 120 includes an operating system that allows users to one or more of consolidate, generate, view, or edit data, provide directives to the predictive system 110 (e.g., machine learning processing system), etc.

In some embodiments, corrective action component 122 receives one or more of user input (e.g., via a Graphical User Interface (GUI) displayed via the client device 120), receives image data 142 (e.g., from client device 120, from data store 140), receives pattern data 152, etc. In some embodiments, the corrective action component 122 one or more of transmits the data (e.g., user input, image data 142, pattern data 152, etc.) to the predictive system 110, receives predictive data 160 from the predictive system 110, determines fault event recovery (e.g., performance of a corrective action) based on the predictive data 160, and/or causes performance of a corrective action (e.g., interruption of one or more components). In some embodiments, the corrective action component 122 stores data (e.g., user input, image data 142, pattern data 152, etc.) in the data store 140 and the predictive server 112 retrieves data from the data store 140. In some embodiments, the predictive server 112 stores output (e.g., predictive data 160) of the trained machine learning model 190 in the data store 140 and the client device 120 retrieves the output from the data store 140. In some embodiments, the corrective action component 122 receives an indication of a corrective action (e.g., based on predictive data 160) from the predictive system 110 and causes substrates to be processed based on the corrective action.

In some embodiments, the predictive data 160 is associated with predicted performance data (e.g., predicted pattern data). In some embodiments, a corrective action is performed based on the predictive data 160. In some embodiments, the corrective action includes one or more of providing an alert (e.g., an alarm to not use one or more parts of the substrate processing equipment 123 if the predictive data 160 indicates a predicted abnormality, etc.), updating manufacturing parameters, predicting failure of the substrate processing equipment 123, causing replacement of at least a portion of the substrate processing equipment 123, interrupting operation of one or more portions of the substrate processing equipment 123, etc. In some embodiments, the corrective action includes providing feedback control (e.g., cleaning, repairing, and/or replacing one or more parts of the substrate processing equipment 123 responsive to the predictive data 160 indicating a predicted abnormality). In some embodiments, the corrective action includes providing machine learning (e.g., determining a predicted component that is to have a fault event based on the predictive data 160).

In some embodiments, the predictive server 112, server machine 170, and server machine 180 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

The predictive server 112 includes a predictive component 114. In some embodiments, the predictive component 114 receives image data 142 (e.g., receives from the client device 120, retrieves from the data store 140) and generates predictive data 160 associated with a defect inspection (e.g., causing performance of a corrective action). In some embodiments, the predictive component 114 uses one or more trained machine learning models 190 to determine the predictive data 160 associated with a defect inspection (e.g., causing performance of a corrective action). In some embodiments, the trained machine learning model 190 is trained using historical sensor data (e.g., historical image data 144) and historical performance data (e.g., historical pattern data 154).

In some embodiments, the predictive system 110 (e.g., the predictive server 112, the predictive component 114) generates predictive data 160 using supervised machine learning (e.g., supervised data set, historical image data 144 labeled with historical pattern data 154, etc.). In some embodiments, the predictive system 110 generates predictive data 160 using semi-supervised learning (e.g., historical image data 144 is of normal substrate runs, semi-supervised data set, pattern data 152 is a predictive percentage, etc.). In some embodiments, the predictive system 110 generates predictive data 160 using unsupervised machine learning (e.g., unsupervised data set, clustering, clustering based on historical image data 144, etc.).

In some embodiments, the substrate processing equipment 123 (e.g., cluster tool) is part of a substrate processing system (e.g., integrated processing system). The substrate processing equipment 123 includes one or more of a controller, an enclosure system (e.g., substrate carrier, front opening unified pod (FOUP), auto teach FOUP, process kit enclosure system, substrate enclosure system, cassette, etc.), a side storage pod (SSP), an aligner device (e.g., aligner chamber), a factory interface (e.g., equipment front end module (EFEM)), a load lock, a transfer chamber, one or more processing chambers (e.g., that produce plasma), a robot arm (e.g., disposed in the transfer chamber, disposed in the front interface, etc.), and/or the like. The enclosure system, SSP, and load lock mount to the factory interface and a robot arm disposed in the factory interface is to transfer content (e.g., substrates, process kit rings, carriers, validation wafer, etc.) between the enclosure system, SSP, load lock, and factory interface. The aligner device is disposed in the factory interface to align the content. The load lock and the processing chambers mount to the transfer chamber and a robot arm disposed in the transfer chamber is to transfer content (e.g., substrates, process kit rings, carriers, validation wafer, etc.) between the load lock, the processing chambers, and the transfer chamber. In some embodiments, the image data 142 is associated with the substrate 192 being inspected by the inspection system 100, where the substrate was produced or at least partially processed by the substrate processing equipment 123.

The inspection system 100 may include inspection equipment 124, which may include sensors 126 and/or the light device 129. In some embodiments, the sensors 126 provide sensor data (e.g., image data 142, sensor values such as historical sensor values and current sensor values) associated with the inspection system 100. The sensors 126 may include an optical modulator 127, and/or an image detector 128 (e.g., camera, image capturing device, etc.). In some embodiments, the sensor data (e.g., image data 142) is used for equipment health and/or product health (e.g., product quality). In some embodiments, the sensor data is received over a period of time. In some embodiments, sensors 126 provide sensor data such as image data 142. In some embodiments, the image data 142 and/or pattern data 152 includes sensor data from one or more of sensors 126.

In some embodiments, the image data 142 (e.g., historical image data 144, current image data 146, etc.) is processed by the client device 120 and/or by the predictive server 112. In some embodiments, processing of the image data 142 includes generating features. In some embodiments, the features are a portion of the sensor data, processed sensor data, pattern in the image data 142, or a combination of values from the image data 142 (e.g., ratio of sensor values, etc.). In some embodiments, the image data 142 includes features that are used by the predictive component 114 for obtaining predictive data 160.

In some embodiments, the data store 140 is memory (e.g., random access memory), a drive (e.g., a hard drive, a flash drive), a database system, or another type of component or device capable of storing data. In some embodiments, data store 140 includes multiple storage components (e.g., multiple drives or multiple databases) that span multiple computing devices (e.g., multiple server computers). In some embodiments, the data store 140 stores one or more of image data 142, pattern data 152, and/or predictive data 160.

Image data 142 includes historical image data 144 and current image data 146. In some embodiments, image data 142 may be associated with a first substrate surface, including reflected light from the first substrate surface that contacts the image detector 128 and/or blocked light (e.g., reflected light that is diverted away from the image detector 128). In some embodiments, at least a portion of the image data 142 is from client device 120, data store 140, and/or sensors 126.

Pattern data 152 (e.g., performance data) includes historical pattern data 154 (e.g., historical performance data) and current pattern data 156 (e.g., current performance data). In some embodiments, at least a portion of the pattern data 152 is associated with whether property data of substrates meets threshold property values (e.g., whether the substrates are good substrates, whether the substrates are from normal substrate runs). The pattern data 152 may include whether the one or more substrates are faulty. Pattern data 152 may include property values of a substrate, an indication of whether property values of a substrate meet threshold values, etc. In some examples, the pattern data 152 is indicative of whether a substrate is properly designed (e.g., has the correct etch pattern), properly produced, and/or properly functioning. In some embodiments, at least a portion of the pattern data 152 is associated with a quality of substrates produced by the substrate processing equipment 123. In some embodiments, at least a portion of the pattern data 152 is based on sensor data from the sensors 126 (e.g., historical pattern data 154 includes sensor data indicating properly processed substrates, property data of substrates, yield, etc.). In some embodiments, at least a portion of the pattern data 152 is based on inspection of the substrates (e.g., current pattern data 156 based on actual inspection) by the inspection system 100.

In some embodiments, the client device 120 provides pattern data 152 (e.g., performance data). In some examples, the client device 120 provides (e.g., based on user input) pattern data 152 that indicates an abnormality in substrates (e.g., defective substrates). In some embodiments, the pattern data 152 includes an amount of substrates that have been produced that were normal or abnormal (e.g., 98% normal substrates). In some embodiments, the pattern data 152 indicates an amount of substrates that are being produced that are predicted as normal or abnormal. In some embodiments, the pattern data 152 includes one or more of yield a previous batch of substrates, average yield, predicted yield, predicted amount of defective or non-defective product, or the like.

In some embodiments, historical data includes one or more of historical image data 144 and/or historical pattern data 154 (e.g., at least a portion for training the machine learning model 190). Current data includes one or more of current image data 146 and/or current pattern data 156 (e.g., at least a portion to be input into the trained machine learning model 190 subsequent to training the model 190 using the historical data). In some embodiments, the current data is used for retraining the trained machine learning model 190.

In some embodiments, the predictive data 160 is to be used for defect inspection (e.g., to cause performance of a corrective action).

In some embodiments, predictive system 110 further includes server machine 170 and server machine 180. Server machine 170 includes a data set generator 172 that is capable of generating data sets (e.g., a set of data inputs and a set of target outputs) to train, validate, and/or test a machine learning model(s) 190. The data set generator 172 has functions of data gathering, compilation, reduction, and/or partitioning to put the data in a form for machine learning. In some embodiments (e.g., for small datasets), partitioning (e.g., explicit partitioning) for post-training validation is not used. Repeated cross-validation (e.g., 5-fold cross-validation, leave-one-out-cross-validation) may be used during training where a given dataset is in-effect repeatedly partitioned into different training and validation sets during training. A model (e.g., the best model, the model with the highest accuracy, etc.) is chosen from vectors of models over automatically-separated combinatoric subsets. In some embodiments, the data set generator 172 may explicitly partition the historical data (e.g., historical image data 144 and corresponding historical pattern data 154) into a training set, a validating set, and/or a testing set. In some embodiments, the predictive system 110 (e.g., via predictive component 114) generates multiple sets of features (e.g., training features). In some examples, a first set of features corresponds to a first set of types of image data 142 (e.g., first types of operations, associated with a first set of sensors, first combination of values, first patterns in the values) that correspond to each of the data sets (e.g., training set, validation set, and testing set) and a second set of features correspond to a second set of types of image data 142 (e.g., second types of operations, associated with a second set of sensors different from the first set of sensors, second combination of values different from the first combination, second patterns different from the first patterns) that correspond to each of the data sets.

Server machine 180 includes a training engine 182, a validation engine 184, selection engine 185, and/or a testing engine 186. In some embodiments, an engine (e.g., training engine 182, a validation engine 184, selection engine 185, and a testing engine 186) refers to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 is capable of training a machine learning model 190 using one or more sets of features associated with the training set from data set generator 172. In some embodiments, the training engine 182 generates multiple trained machine learning models 190, where each trained machine learning model 190 corresponds to a distinct set of parameters of the training set (e.g., image data 142) and corresponding responses (e.g., pattern data 152). In some embodiments, multiple models are trained on the same parameters with distinct targets for the purpose of modeling multiple effects.

The validation engine 184 is capable of validating a trained machine learning model 190 using a corresponding set of features of the validation set from data set generator 172. For example, a first trained machine learning model 190 that was trained using a first set of features of the training set is validated using the first set of features of the validation set. The validation engine 184 determines an accuracy of each of the trained machine learning models 190 based on the corresponding sets of features of the validation set. The validation engine 184 evaluates and flags (e.g., to be discarded) trained machine learning models 190 that have an accuracy that does not meet a threshold accuracy. In some embodiments, the selection engine 185 is capable of selecting one or more trained machine learning models 190 that have an accuracy that meets a threshold accuracy. In some embodiments, the selection engine 185 is capable of selecting the trained machine learning model 190 that has the highest accuracy of the trained machine learning models 190.

The testing engine 186 is capable of testing a trained machine learning model 190 using a corresponding set of features of a testing set from data set generator 172. For example, a first trained machine learning model 190 that was trained using a first set of features of the training set is tested using the first set of features of the testing set. The testing engine 186 determines a trained machine learning model 190 that has the highest accuracy of all of the trained machine learning models based on the testing sets.

In some embodiments, the machine learning model 190 (e.g., used for classification) refers to a model artifact that is created by the training engine 182 using a training set that includes data inputs and corresponding target outputs (e.g., correctly classifies a condition or ordinal level for respective training inputs). Patterns in the data sets can be found that map the data input to the target output (the correct classification or level), and the machine learning model 190 is provided mappings that captures these patterns. In some embodiments, the machine learning model 190 uses one or more of Gaussian Process Regression (GPR), Gaussian Process Classification (GPC), Bayesian Neural Networks, Neural Network Gaussian Processes, Deep Belief Network, Gaussian Mixture Model, or other Probabilistic Learning methods. Non probabilistic methods may also be used including one or more of Support Vector Machine (SVM), Radial Basis Function (RBF), clustering, Nearest Neighbor algorithm (k-NN), linear regression, random forest, neural network (e.g., artificial neural network), etc. In some embodiments, the machine learning model 190 is a multi-variate analysis (MVA) regression model.

Predictive component 114 provides current image data 146 (e.g., as input) to the trained machine learning model 190 and runs the trained machine learning model 190 (e.g., on the input to obtain one or more outputs). The predictive component 114 is capable of determining (e.g., extracting) predictive data 160 from the trained machine learning model 190 and determines (e.g., extracts) uncertainty data that indicates a level of credibility that the predictive data 160 corresponds to current pattern data 156. In some embodiments, the predictive component 114 or corrective action component 122 use the uncertainty data (e.g., uncertainty function or acquisition function derived from uncertainty function) to decide whether to use the predictive data 160 to perform a corrective action (e.g., interrupt operation of one or more components) or whether to further train the model 190.

For purpose of illustration, rather than limitation, aspects of the disclosure describe the training of one or more machine learning models 190 using historical data (i.e., prior data, historical image data 144, and historical pattern data 154) and providing current image data 146 into the one or more trained probabilistic machine learning models 190 to determine predictive data 160. In other implementations, a heuristic model or rule-based model is used to determine predictive data 160 (e.g., without using a trained machine learning model). In other implementations non-probabilistic machine learning models may be used. Predictive component 114 monitors historical image data 144 and historical pattern data 154.

In some embodiments, the functions of client device 120, predictive server 112, server machine 170, and server machine 180 are provided by a fewer number of machines. For example, in some embodiments, server machines 170 and 180 are integrated into a single machine, while in some other embodiments, server machine 170, server machine 180, and predictive server 112 are integrated into a single machine. In some embodiments, client device 120 and predictive server 112 are integrated into a single machine.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 determines corrective actions based on the predictive data 160. In another example, client device 120 determines the predictive data 160 based on data received from the trained machine learning model 190.

In addition, the functions of a particular component can be performed by different or multiple components operating together. In some embodiments, one or more of the predictive server 112, server machine 170, or server machine 180 are accessed as a service provided to other systems or devices through appropriate application programming interfaces (API).

In some embodiments, a “user” is represented as a single individual. However, other embodiments of the disclosure encompass a “user” being an entity controlled by a plurality of users and/or an automated source. In some examples, a set of individual users federated as a group of administrators is considered a “user.”

Although embodiments of the disclosure are discussed in terms of determining predictive data 160 for defect inspection (e.g., to perform a corrective action), in some embodiments, the disclosure can also be generally applied to monitoring of components (e.g., to perform a corrective action).

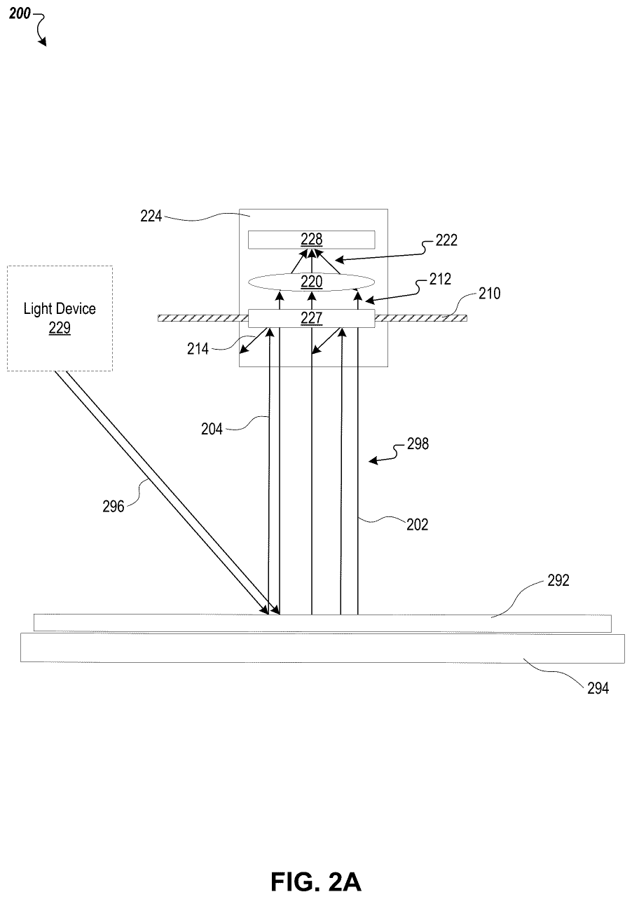

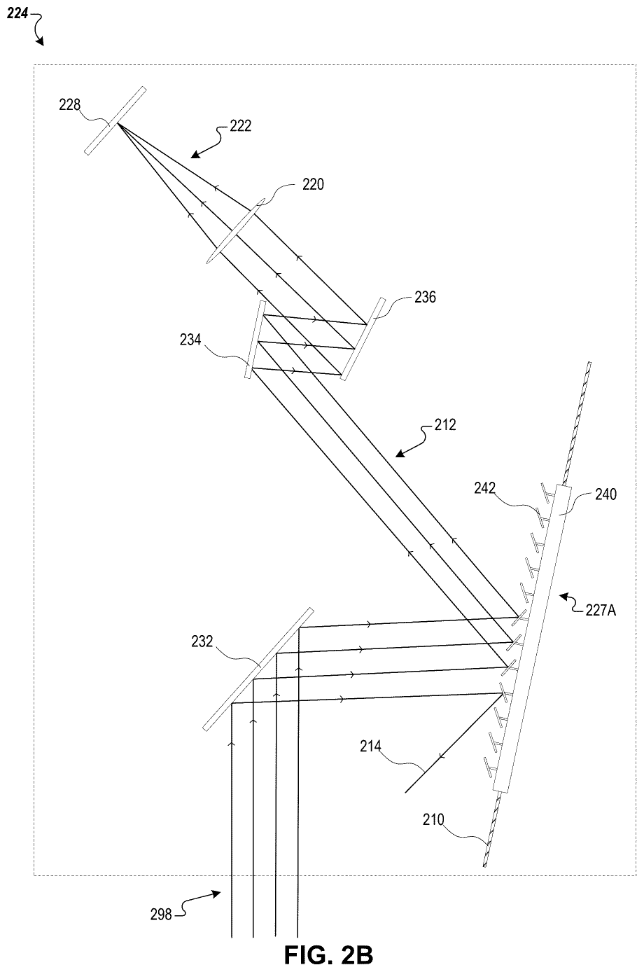

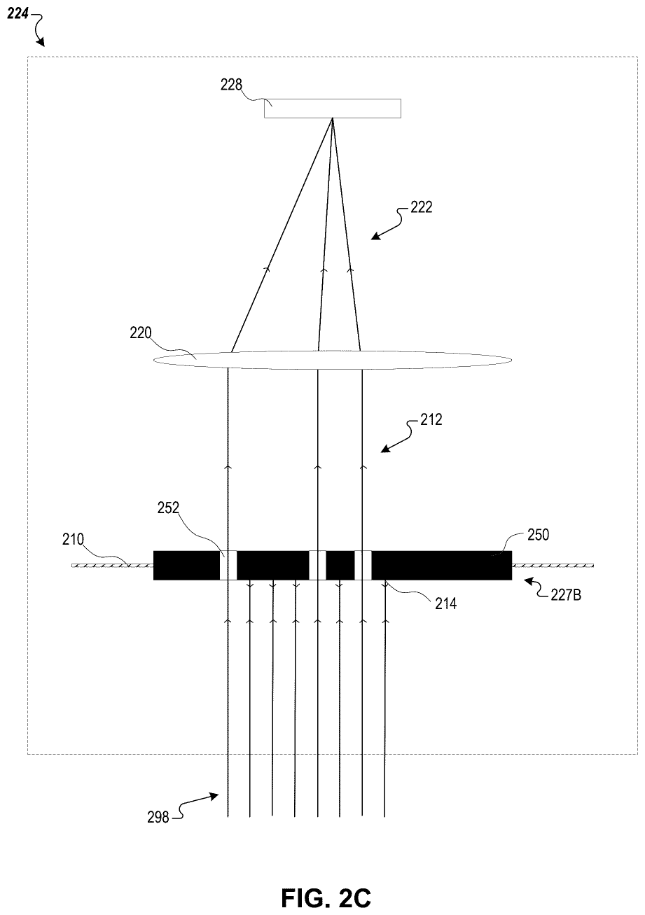

FIGS. 2A-C illustrate inspection systems 200 (e.g., inspection system 100 of FIGS. 1A and/or 1B) including an optical modulator 227 (e.g., optical modulator 127 of FIGS. 1A and/or 1B), according to some embodiments. FIG. 2A illustrates an inspection system 200, according to some embodiments. FIG. 2B illustrates an optical modulator 227A of the inspection system 200 including a microelectromechanical system (MEMS) digital micromirror device (DMD) and a compensator, according to some embodiments. FIG. 2C illustrates an optical modulator 227B of the inspection system 200 including a liquid crystal display (LCD), according to some embodiment. Components and features of FIGS. 1A, 1B, 2A, 2B, and/or 2C that have the same or similar name and/or reference number may have the same or similar functionality, material, components, etc.

The inspection system 200 may include a substrate support 294 (e.g., the substrate support 194 of FIGS. 1A and/or 1B) configured to receive a substrate 292 (e.g., the substrate 192 of FIGS. 1A and/or 1B). The inspection system 200 may include inspection equipment 224 (e.g., inspection equipment 124 of FIGS. 1A and/or 1B). The inspection equipment 224 may include light device 229 (e.g., the light device 129 of FIGS. 1A and/or 1B) configured to provide light 296 (e.g., light 196 of FIGS. 1A and/or 1B) to the substrate 292. In some embodiments, the light device 229 is integral to the inspection equipment 224. In some embodiments, the light device 229 is separate from the inspection equipment 224.

The substrate 292 may reflect the light 296 from the light device 229 to the inspection equipment 224 as reflected light 298 (e.g., reflected light 198 of FIGS. 1A and/or 1B). The reflected light 298 may include a variety of reflect light rays, each having a reflected light intensity. The reflected light 298 may encounter the optical modulator 227 located at a pupil plane 210 of the image detector 228 (e.g., image detector 128 of FIGS. 1A and/or 1B). A pupil plane is a location in space where a virtual image of an object is seen through a lens. For instance, when looking through a lens (e.g., the image lens 220) toward the image detector 228, the image detector 228 may appear to be in a different position in space than the actual location of the image detector 228. This appearance in a different position is known as a virtual image, and the location of the different position (e.g., where the light field is a Fourier transfer of the actual light field emerging from a surface of the substrate 292) is the pupil plane. By positioning the optical modulator 227 at the pupil plane 210 of the inspection equipment 224, a greater portion of the reflected light 298 may reach (e.g., pass through, be directed by) the optical modulator 227, thus enabling the optical modulator 227 to filter more of the reflected light 298.

In some embodiments, the optical modulator 227 acts as a filter for the reflected light 298 by providing (e.g., permitting to pass through) light from the substrate with certain intensities (e.g., lower intensities, light that is typically non-periodic and/or does not repeat in regular patterns, light that is associated with a defect of the substrate surface) to the image lens 220 and preventing (e.g., blocking) light from the substrate with other intensities (e.g., higher intensities that typically come from a designed and/or intentional periodic pattern of a surface of the substrate 292) from arriving at the image lens 220. The filter may be a Fourier filter, which is an optical filter that selectively prevents (e.g., removes, blocks) a standard intensity 202, which is reflected light 298 associated with the substrate 292 (e.g., reflected light 298 with intensities associated with a standard substrate 292, an expected etching pattern of the substrate 292, and/or a regular, periodic designed structure on the first surface of the substrate 292). The Fourier filter may be configured to selectively provide (e.g., permit) a non-standard intensity 204, which is the reflected light 298 associated with one or more defects of the substrate 292 (e.g., reflected light 298 with intensities associated with a non-standard substrate 292 and/or an unexpected etching pattern of the substrate 292). In some embodiments, an occurrence of the standard intensity 202 greatly exceeds an occurrence of the non-standard intensity 204, and the optical modulator 227 prevents (e.g., blocks) the standard intensity 202 based on this greater occurrence.

The non-standard intensity 204 may be provided by (e.g., permitted to transmit through) the optical modulator 227 as permitted light 212 to reach the image lens 220. The permitted light 212 may then be directed by the image lens 220 to the image detector 228 as converging light 222. In some embodiments, the image lens 220 performs an inverse Fourier transfer that converts the light field of the pupil plane back into an image of the structures on a surface of the substrate 292. The image (e.g., a converted image) is interpreted (e.g., recorded, stored) by the image detector 228 as image data. The image data associated with the converging light 222 may be interpreted (e.g., by image detector 128, by a processing device) as image data associated with one or more defects of the substrate 292.

FIG. 2B illustrates an optical modulator 227A of the inspection system 200 including a MEMS DMD 240, a beam splitter 232, a compensator 234, and an optional redirection mirror 236, according to some embodiments. In some embodiments, the beam splitter 232, the compensator 234, and/or the redirection mirror 236 are used to redirect light (e.g., reflected light 298 and/or permitted light 212) within the inspection equipment 224. Light may be redirected to accommodate for the various reflection angles from one or more micromirrors 242 of the MEMS DMD 240.

In some embodiments, the reflected light 298 enters the inspection equipment 224 and interacts with the beam splitter 232 configured to redirect the reflected light 298 toward the optical modulator 227A. In some embodiments, the beam splitter 232 selects light from the substrate to be filtered by the optical modulator 227A from light to be filtered in different ways (e.g., such as a dark field channel vs. a bright field channel; the selection mechanisms can be based on light wavelength (dichroic mirror), polarization states (polarizer), and/or one or more spatial characteristics of the light). The optical modulator 227A may be a MEMS DMD 240, which includes one or more micromirrors 242 that may be in a first configuration (e.g., first angle, first micromirror angle) or a second configuration (e.g., second angle different than the first angle, second micromirror angle different than the first micromirror angle).

The first configuration may correspond to a first micromirror angle and may redirect the light (e.g., the permitted light 212) toward the compensator 234 (e.g., a chromatic aberration compensator), the redirection mirror 236, the image lens 220, and/or the image detector 228. The first configuration may be associated with one or more defects of a first substrate surface (e.g., of the substrate 292 of FIG. 2A). A first subset of a group of portions of the optical modulator 227A (e.g., a first set of micromirrors 242 of the group of micromirrors 242 of the MEMS DMD 240) may be in the first configuration responsive to a non-standard intensity 204 associated with one or more defects of the first substrate surface. The first substrate surface may be used as a basis for comparing and/or evaluating a second substrate surface for defects. In some embodiments, a third subset of the group of portions of the optical modulator 227A (e.g., a third set of micromirrors 242 of the group of micromirrors 242 of the MEMS DMD 240) that is different from the first subset is in the first configuration responsive to a non-standard intensity 204 associated with one or more defects of the second substrate surface. The third subset may be in the first configuration within about 0.5 milliseconds (ms) to about 100 ms of the first subset being in the first configuration (e.g., may switch within about 0.5 to about 100 ms).

The second configuration may correspond to a second micromirror angle and may redirect the light (e.g., the blocked light 214) away from the chromatic aberration compensator 234. In some embodiments, the blocked light 214 is directed away from the image detector 228 and any other component that could redirect the blocked light 214 toward the image detector 228. For example, the second configuration may prevent the blocked light 214 from interacting with another micromirror of the MEMS DMD 240 and/or other internal structures of the inspection equipment 224 to prevent any portion of the blocked light 214 from reflecting toward and/or reaching the image detector 228. The second configuration may be associated with a substantially non-defective portion of the first substrate surface (e.g., a standard substrate and/or an expected etching pattern of the substrate). A second subset of the group of portions of the optical modulator 227A (e.g., a second set of micromirrors 242 of the group of micromirrors 242 of the MEMS DMD 240) may be in the second configuration responsive to a standard intensity 202 associated with first substrate surface. In some embodiments, a fourth subset of the group of portions of the optical modulator 227A (e.g., a fourth set of micromirrors 242 of the group of micromirrors 242 of the MEMS DMD 240) that is different from the second subset is in the second configuration responsive to a standard intensity 202 associated with the second substrate surface. The fourth subset may be in the second configuration within about 0.5 ms to about 100 ms of the second subset being in the second configuration.

In some embodiments, the first subset being in the first configuration and the second subset being in the second configuration is based on first pattern data of the first substrate surface. The first pattern data may be identified based on image data of the first substrate surface. In some embodiments, the third subset being in the first configuration and the fourth subset being in the second configuration is based on second pattern data of the second substrate surface. The second pattern data may be identified based on image data of the second substrate surface.

FIG. 2C illustrates an optical modulator 227B of the inspection system 200 including a liquid crystal display (LCD) 250, according to some embodiments. The LCD 250 may include a group of pixels 252. Each pixel 252 of the group of pixels 252 may be in either a first configuration or a second configuration.

In some embodiments, the first configuration corresponds to a first pixel configuration that allows light transmission (e.g., is optically transmissive such that light may pass through). The first configuration may permit the reflected light 298 to pass through the optical modulator 227B, the image lens 220, and reach the image detector 228. The first configuration may be associated with one or more defects of the first substrate surface (e.g., the first subset of the group of pixels of the LCD) and/or the second substrate surface (e.g., the third subset of the group of pixels of the LCD).

In some embodiments, the second configuration corresponds to a second pixel configuration that prevents light transmission (e.g., is optically non-transmissive such that light may not pass through). The second configuration may prevent the reflected light 298 from passing through the optical modulator 227B and/or reaching the image detector 228. The second configuration may be associated with a substantially non-defective portion (e.g., a standard substrate and/or an expected etch pattern) of the first substrate surface (e.g., the second subset of the group of pixels of the LCD) and/or the second substrate surface (e.g., the fourth subset of the group of pixels of the LCD).

In some embodiments, the first subset being in the first configuration and the second subset being in the second configuration is based on first pattern data of the first substrate surface. The first pattern data may be identified based on image data of the first substrate surface. In some embodiments, the third subset being in the first configuration and the fourth subset being in the second configuration is based on second pattern data of the second substrate surface. The second pattern data may be identified based on image data of the second substrate surface.

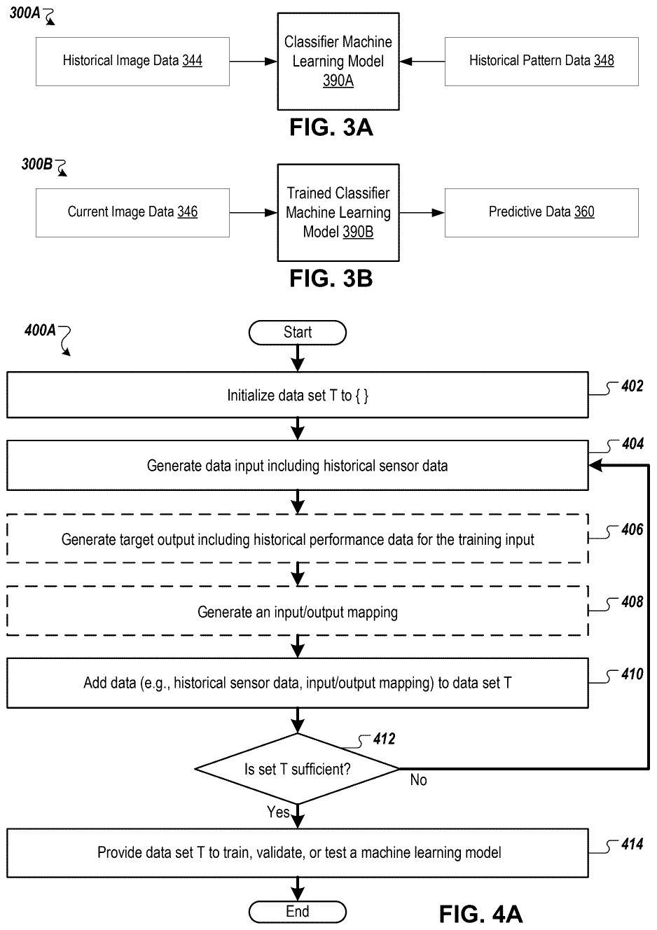

FIGS. 3A-B are block diagrams 300A-B illustrating machine learning models (e.g., model 190 of FIG. 1B) associated with defect inspection, according to some embodiments. In some embodiments, FIGS. 3A-B are associated with classifier models (e.g., random forest classifiers). In some embodiments, a classifier model is used if image data (e.g., sensor data, image data 142 of FIG. 1B) and pattern data (e.g., performance data, pattern data 152 of FIG. 1B) are both available. Classifier models may have a supervised capability to determine good (e.g., substrates that meet threshold property values) or bad (e.g., substrates that do not meet threshold property values) conditions. Classifier models may use random forest classifier due to robustness.

FIG. 3A is a block diagram illustrating training a defect inspection machine learning model 390A, according to some embodiments. Historical image data 344 (e.g., historical image data 144 of FIG. 1B) may be provided as data input and historical pattern data 348 (e.g., historical pattern data 154 of FIG. 1B) may be provided as target output to train classifier machine learning model 390A. The historical image data 344 may be associated with historical substrate surfaces, including reflected light from the historical substrate surfaces that contacts the image detector and/or blocked light (e.g., reflected light that is diverted away from the image detector). Historical pattern data 348 may be an indication if a substrate inspected based on the historical image data 344 is good or bad (e.g., meets threshold property values, image data, whether meets threshold data, label, etc.).

FIG. 3B is a block diagram illustrating use (e.g., runtime inference) of a trained classifier machine learning model 390B (e.g., the model 190 of FIG. 1), according to some embodiments. The trained classifier machine learning model 390B may be a classifier machine learning model 390A that was trained as illustrated in FIG. 3A.

Current image data 346 (e.g., current image data 146 of FIG. 1B) may be provided as input to the trained classifier machine learning model 390B and the trained classifier machine learning model 390B may output predictive data 360 (e.g., predictive data 160 of FIG. 1B). The current image data 346 may be associated with a current substrate surface (e.g., a current substrate being inspected), including reflected light from the current substrate surface that contacts the image detector and/or blocked light (e.g., reflected light that is diverted away from the image detector). Predictive data 360 may be a prediction of whether a substrate inspected based on the current image data 346 is good or bad (e.g., predicted to meet threshold property values, image data, whether meets threshold data, output label, etc.). Predictive data 360 from the trained classifier machine learning model 390B may be used for defect inspection (e.g., to perform a corrective action).

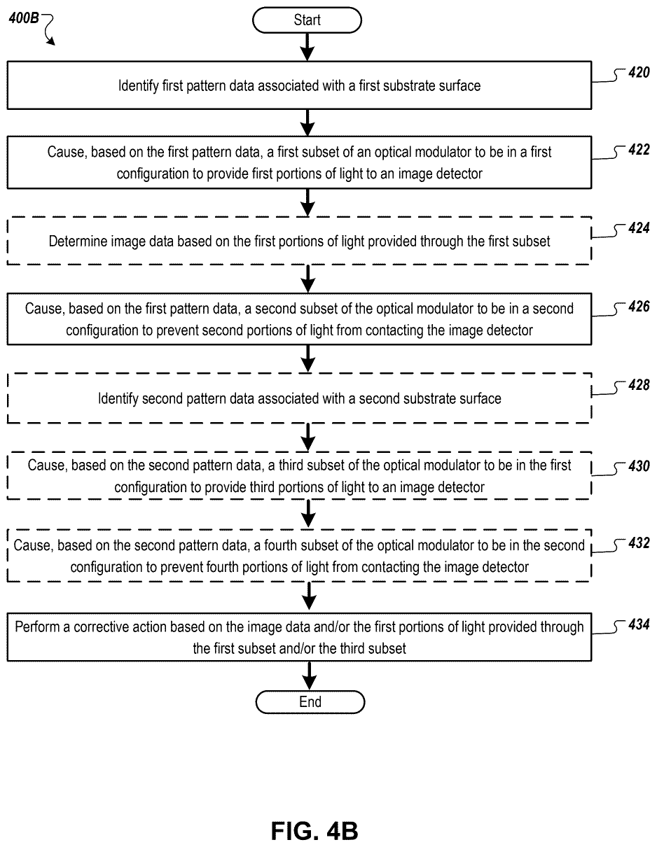

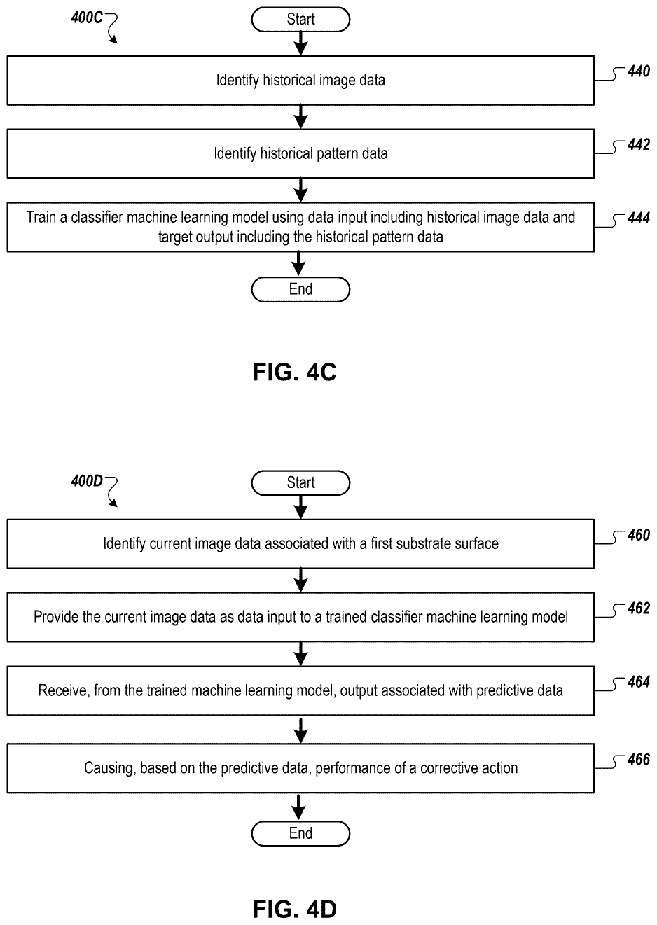

FIGS. 4A-D are flow diagrams of methods 400A-D associated with defect inspection, according to certain embodiments. In some embodiments, methods 400A-D are performed by processing logic that includes hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, methods 400A-D are performed, at least in part, by predictive system 110 and/or client device 120. In some embodiments, method 400A is performed, at least in part, by predictive system 110 (e.g., server machine 170 and data set generator 172 of FIG. 1). In some embodiments, predictive system 110 uses method 400A to generate a data set to at least one of train, validate, or test a machine learning model. In some embodiments, method 400B is performed by the client device 120 (e.g., the corrective action component 122). In some embodiments, method 400C is performed by the server machine 180 (e.g., the training engine 182, etc.). In some embodiments, method 400D is performed by the predictive server 112 (e.g., the predictive component 114). In some embodiments, a non-transitory machine-readable storage medium stores instructions that when executed by a processing device (e.g., of predictive system 110, of server machine 180, of predictive server 112, etc.), cause the processing device to perform one or more of methods 400A-D.

For simplicity of explanation, methods 400A-D are depicted and described as a series of operations. However, operations in accordance with this disclosure can occur in various orders and/or concurrently and with other operations not presented and described herein. Furthermore, in some embodiments, not all illustrated operations are performed to implement methods 400A-D in accordance with the disclosed subject matter. In addition, those skilled in the art will understand and appreciate that methods 400A-D could alternatively be represented as a series of interrelated states via a state diagram or events.

FIG. 4A is a flow diagram of a method 400A for generating a data set for a machine learning model for generating predictive data (e.g., the predictive data 160 of FIG. 1B), according to some embodiments.

Referring to FIG. 4A, in some embodiments, at block 402 the processing logic (e.g., predictive component 114 of predictive server 112 of FIG. 1B, the processing device or control logic 102 of FIG. 1A) implementing method 400A initializes a training set T to an empty set.

At block 404, processing logic generates first data input (e.g., first training input, first validating input) that includes historical image data (e.g., the historical image data 144 of FIG. 1B). In some embodiments, the first data input includes a first set of features for types of sensor data and a second data input includes a second set of features for types of sensor data.

In some embodiments, at block 406, processing logic generates a first target output for one or more of the data inputs (e.g., first data input). In some embodiments, the first target output is historical pattern data (e.g., the historical pattern data 154 of FIG. 1B).

In some embodiments, at block 408, processing logic optionally generates mapping data that is indicative of an input/output mapping. The input/output mapping (or mapping data) refers to the data input (e.g., one or more of the data inputs described herein), the target output for the data input (e.g., where the target output identifies the historical pattern data 154), and an association between the data input(s) and the target output.

At block 410, processing logic adds the data (e.g., the historical image data from block 404, mapping data generated at block 408) to data set T.

At block 412, processing logic branches based on whether data set T is sufficient for at least one of training, validating, and/or testing machine learning model 190 (e.g., uncertainty of the trained machine learning model meets a threshold uncertainty). If so, execution proceeds to block 414, otherwise, execution continues back to block 404. It should be noted that in some embodiments, the sufficiency of data set T is determined based simply on the number of input/output mappings in the data set, while in some other implementations, the sufficiency of data set T is determined based on one or more other criteria (e.g., a measure of diversity of the data examples, accuracy, etc.) in addition to, or instead of, the number of input/output mappings.

At block 414, processing logic provides data set T (e.g., to the server machine 180) to train, validate, and/or test the machine learning model 190. In some embodiments, data set T is a training set and is provided to the training engine 182 of the server machine 180 to perform the training. In some embodiments, data set T is a validation set and is provided to the validation engine 184 of server machine 180 to perform the validating. In some embodiments, data set T is a testing set and is provided to the testing engine 186 of the server machine 180 to perform the testing. In the case of a neural network, for example, input values of a given input/output mapping (e.g., numerical values associated with data inputs) are input to the neural network, and output values (e.g., numerical values associated with target outputs) of the input/output mapping are stored in the output nodes of the neural network. The connection weights in the neural network are then adjusted in accordance with a learning algorithm (e.g., back propagation, etc.), and the procedure is repeated for the other input/output mappings in data set T.

After block 414, a machine learning model (e.g., the machine learning model 190) can be at least one of trained using the training engine 182 of the server machine 180, validated using the validation engine 184 of the server machine 180, and/or tested using the testing engine 186 of the server machine 180. The trained machine learning model is implemented by the predictive component 114 (of the predictive server 112) to generate predictive data (e.g., the predictive data 160) for defect inspection (e.g., to cause performance of a corrective action, etc.). In some embodiments, a data set is generated to train a supervised machine learning model (e.g., data set of block 414 includes data input of block 404 and target output of block 406). In some embodiments, a data set is generated to train an unsupervised machine learning model (e.g., clustering, data set of block 414 includes data input of block 404 but does not include target output of block 406).

FIG. 4B is a flow diagram of a method 400B associated with defect inspection (e.g., to cause performance of a corrective action), according to some embodiments.

In some embodiments, at block 420 of method 400B, processing logic identifies first pattern data associated with a first substrate surface processed via a substrate processing system. Identifying the first pattern data may include identifying image data associated with the first substrate surface and determining the first pattern data based on the image data. In some embodiments, processing logic determines a first portion of the first substrate surface corresponding to first portions of light and a second portion of the first substrate surface corresponding to second portions of light based on the image data. In some embodiments, the first pattern data is associated with the first portion and the second portion of the first substrate surface.

At block 422, the processing logic causes, based on the first pattern data, a first subset (e.g., of a group of portions of an optical modulator) to be in a first configuration to provide the first portions of light to an image detector. The first portions of light may be reflected light (e.g., the reflected light 198 of FIG. 1A) from the first substrate surface. The optical modulator (e.g., the optical modulator 127 of FIG. 1A) may be positioned at a pupil plane of an optical system that is part of inspection equipment (e.g., the inspection equipment 124 of FIG. 1A, etc.). In some embodiments, the optical modulator selectively allows portions of light (e.g., the first portions of light) to reach (e.g., contact) the image detector (e.g., the image detector 128 of FIG. 1A, etc.). In some embodiments, the first portions of light correspond to a defect of the first substrate surface.

The optical modulator may be a MEMS DMD (e.g., as in FIG. 2B). In embodiments where the optical modulator is a MEMS DMD, each of the group of portions of the optical modulator include a corresponding micromirror of the MEMS DMD. In such embodiments, the first configuration corresponds to a first micromirror angle that causes the first portions of light to be directed to the image detector.

The optical modulator may be an LCD (e.g., as in FIG. 2C). In embodiments where the optical modulator is an LCD, each of the group of portions of the optical modulator include a corresponding pixel of the LCD. In such embodiments, the first configuration corresponds to a first pixel configuration that allows light transmission to the image detector via the corresponding pixel.

In some embodiments, at block 424, the processing logic determines the image data based on the first portions of light provided through the first subset. Performance of a corrective action associated with the substrate processing system may be caused based on the image data.

At block 426, the processing logic causes, based on the first pattern data, a second subset (e.g., of the group of portions of the optical modulator) to be in a second configuration to prevent the second portions of light from contacting (e.g., reaching) the image detector. In some embodiments, the second portions of light correspond to a substantially non-defective portion of the first substrate surface (e.g., a standard substrate surface and/or an expected etching pattern of the substrate surface). In embodiments where the optical modulator is a MEMS DMD, the second configuration corresponds to a second micromirror angle that causes the second portions of light to be directed to one or more locations different than the image detector. In embodiments where the optical modulator is an LCD, the second configuration corresponds to a second pixel configuration that prevents the light transmission to the image detector via the corresponding pixel.

In some embodiments, at block 428, the processing logic identifies second pattern data associated with a second substrate surface. At block 430, the processing logic may cause, based on the second pattern data, a third subset (e.g., of the group of portions of the optical modulator) to be in the first configuration to provide third portions of light reflected from the second substrate surface to the image detector. At block 432, the processing logic may cause, based on the second pattern data, a fourth subset (e.g., of the group of portions of the optical modulator) to be in the second configuration to provide fourth portions of light reflected from the second substrate surface to the image detector. In some embodiments, the third subset are in the first configuration and the fourth subset are in the second configuration within about 0.5 ms to about 100 ms of the first subset being in the first configuration and the second subset being in the second configuration.

At block 434, the processing logic performs a corrective action based on the image data and/or the first portions of light provided through the first subset and/or the third subset. In some embodiments, performance of a corrective action includes one or more of causing performance of tool maintenance (e.g., preventative maintenance) and/or tool calibration of the substrate processing system, updating process parameters (e.g., adjustments to temperature, pressure, gas flow, exposure, etc.), causing replacement and/or verification (e.g., of photoresist, chemicals, deposition targets, etc.), updating environmental controls (e.g., adjustment to filtration, airflow, etc.), updating the recipe (e.g., updating the photomask and/or process recipe used in lithography, deposition, etc.), providing an alert, interrupting substrate processing, and/or the like.

FIG. 4C is a flow diagram of a method 400C for training a machine learning model (e.g., the model 190 of FIG. 1B) for determining predictive data (e.g., the predictive data 160 of FIG. 1B) associated with defect inspection, according to some embodiments.

Referring to FIG. 4C, at block 440 of method 400C, the processing logic identifies historical image data (e.g., the historical image data 144 of FIG. 1B). In some embodiments, the historical image data is associated with historical substrate surfaces, including reflected light from the historical substrate surfaces that contacts the image detector and/or blocked light (e.g., reflected light that is diverted away from the image detector), etc.

At block 442, the processing logic identifies historical pattern data (e.g., the historical pattern data 154 of FIG. 1B). In some embodiments, the historical pattern data is associated with quality of substrates (e.g., image data) inspected using the historical image data. In some embodiments, the historical pattern data is indicative of whether one or more components are malfunctioning during the processing of the substrate from which the historical image data of block 440 is identified.

At block 444, the processing logic trains a classifier machine learning model using data input including historical image data and target output including the historical pattern data to generate a trained classifier machine learning model (e.g., configured to provide output associated with the performance of the corrective action). The defect inspection (e.g., to perform a corrective action of block 434 of FIG. 4B) may be by using the trained classifier machine learning model of FIG. 4C. In some embodiments, the trained machine learning model is a neural network. In some embodiments, only historical image data is identified (e.g., historical pattern data is not identified) and the classifier machine learning model is trained using data input including the historical image data (e.g., is an unsupervised model, clustering, is not trained using target output).

FIG. 4D is a flow diagram of a method 400D for using a trained machine learning model (e.g., the model 190 of FIG. 1B) associated with defect inspection (e.g., to cause performance of a corrective action), according to some embodiments. FIG. 4D may be used for block 434 of FIG. 4B.

Referring to FIG. 4D, at block 460 of method 400D, the processing logic identifies current image data. In some embodiments, the current image data is associated with a current substrate surface (e.g., a current substrate being inspected), including reflected light from the current substrate surface that contacts the image detector and/or blocked light (e.g., reflected light that is diverted away from the image detector), etc.

At block 462, the processing logic provides the current image data as data input to a trained classifier machine learning model (e.g., trained via block 444 of FIG. 4C).

At block 464, the processing logic receives, from the trained classifier machine learning model, output associated with predictive data (e.g., associated with performance of a corrective action).

At block 466, the processing logic causes, based on the predictive data, performance of a corrective action (e.g., performance of a corrective action of block 434 of FIG. 4B).

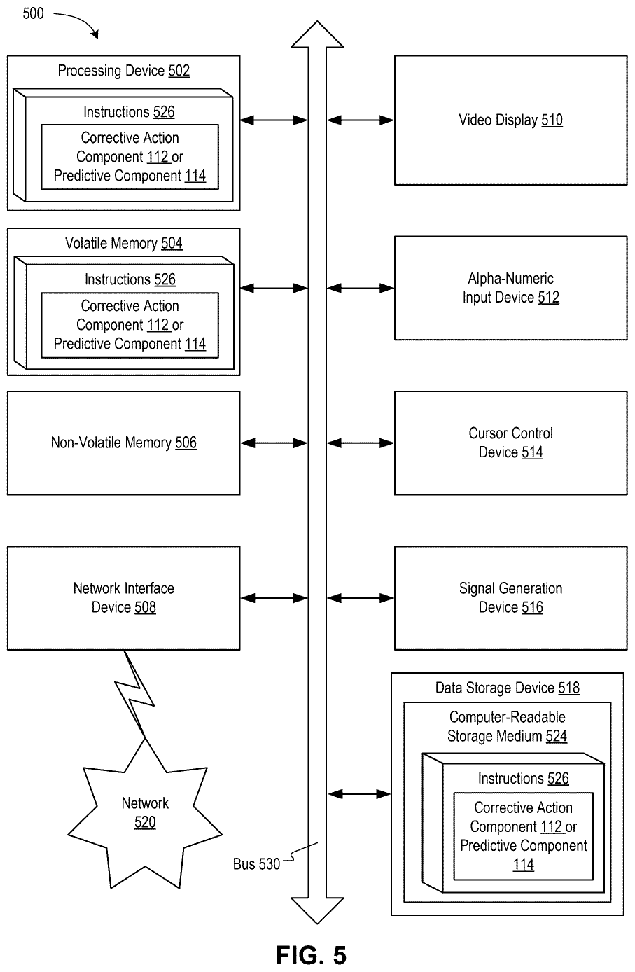

FIG. 5 is a block diagram illustrating an example computer system 500 according to some embodiments. In some embodiments, the computer system 500 is one or more of the client device 120, the predictive system 110, the server machine 170, the server machine 180, and/or the predictive server 112 of FIG. 1B.

In some embodiments, computer system 500 is connected (e.g., via a network, such as a Local Area Network (LAN), an intranet, an extranet, or the Internet) to other computer systems. In some embodiments, computer system 500 operates in the capacity of a server or a client computer in a client-server environment, or as a peer computer in a peer-to-peer or distributed network environment. In some embodiments, computer system 500 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 includes a processing device 502, a volatile memory 504 (e.g., Random Access Memory (RAM)), a non-volatile memory 506 (e.g., Read-Only Memory (ROM) or Electrically-Erasable Programmable ROM (EEPROM)), and a data storage device 518, which communicate with each other via a bus 530.

In some embodiments, processing device 502 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 500 further includes a network interface device 508 (e.g., coupled to network 520). In some embodiments, computer system 500 also includes a video display 510 (e.g., an LCD), an alpha-numeric input device 512 (e.g., a keyboard), a cursor control device 514 (e.g., a mouse), and a signal generation device 516.

In some implementations, data storage device 518 includes a non-transitory computer-readable storage medium 524 on which store instructions 526 encoding any one or more of the methods or functions described herein, including instructions encoding components of FIG. 1B (e.g., the corrective action component 122, the predictive component 114, etc.) and for implementing methods described herein.

In some embodiments, instructions 526 also reside, completely or partially, within volatile memory 504 and/or within processing device 502 during execution thereof by computer system 500, hence, in some embodiments, volatile memory 504 and processing device 502 also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In some embodiments, the methods, components, and features described herein are implemented by discrete hardware components or are integrated in the functionality of other hardware components such as ASICs, FPGAs, DSPs, or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “identifying,” “receiving,” “causing,” “training,” “generating,” “adding,” “initializing,” “executing,” “providing,” “obtaining,” “interrupting,” “determining,” “transmitting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein or includes a general-purpose computer system selectively programmed by a computer program stored in the computer system. Such a computer program is stored in a computer-readable tangible storage medium.

Some of the methods and illustrative examples described herein are not inherently related to any particular computer or other apparatus. In some embodiments, various general-purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
identifying first pattern data associated with a first substrate surface processed via a substrate processing system; and
causing, based on the first pattern data, a first subset of a plurality of portions of an optical modulator positioned at a pupil plane of an optical system to be in a first configuration to provide first portions of light reflected from the first substrate surface to an image detector and a second subset of the plurality of portions of the optical modulator to be in a second configuration to prevent second portions of light reflected from the first substrate surface from contacting the image detector, wherein performance of a corrective action associated with the substrate processing system is to be based on the first portions of light provided through the first subset.

2. The method of claim 1 further comprising:
determining image data based on the first portions of light provided through the first subset; and
causing, based on the image data, the performance of the corrective action associated with the substrate processing system.

3. The method of claim 1 further comprising:
identifying second pattern data associated with a second substrate surface processed via the substrate processing system; and
causing, based on the second pattern data, a third subset of the plurality of portions of the optical modulator to be in the first configuration to provide third portions of light reflected from the second substrate surface to the image detector and a fourth subset of the plurality of portions of the optical modulator to be in the second configuration to prevent fourth portions of light reflected from the second substrate surface from contacting the image detector.

4. The method of claim 3, wherein the third subset are in the first configuration and the fourth subset are in the second configuration within about 0.5 milliseconds (ms) to about 100 ms of the first subset being in the first configuration and the second subset being in the second configuration.

5. The method of claim 1, wherein:
the optical modulator is a microelectromechanical system (MEMS) digital micromirror device (DMD);
each of the plurality of portions of the optical modulator comprises a corresponding micromirror of the MEMS DMD;
the first configuration corresponds to a first micromirror angle that causes the first portions of light to be directed to the image detector; and
the second configuration corresponds to a second micromirror angle that causes the second portions of light to be directed to one or more locations different than the image detector.

6. The method of claim 1, wherein:
the optical modulator is a liquid crystal display (LCD);
each of the plurality of portions of the optical modulator comprises a corresponding pixel of the LCD;
the first configuration corresponds to a first pixel configuration that allows light transmission via the corresponding pixel; and
the second configuration corresponds to a second pixel configuration that prevents the light transmission via the corresponding pixel.

7. The method of claim 1, wherein the identifying of the first pattern data comprises:
identifying image data associated with the first substrate surface; and
determining, based on the image data, a first portion of the first substrate surface corresponding to the first portions of light and a second portion of the first substrate surface corresponding to the second portions of light, the first pattern data being associated with the first portion of the first substrate surface and the second portion of the first substrate surface.

8. The method of claim 7, wherein the first portions of light correspond to a defect of the first substrate surface and the second portions of light correspond to a substantially non-defective portion of the first substrate surface.

9. The method of claim 1 further comprising:
identifying historical image data associated with historical substrate surfaces;
identifying historical pattern data associated with the historical substrate surfaces; and
training a machine learning model using data input comprising the historical image data and target output comprising the historical pattern data to generate a trained machine learning model, wherein the identifying of the first pattern data is associated with the trained machine learning model.

10. The method of claim 1, wherein the identifying of the first pattern data comprises:
identifying image data associated with the first substrate surface;
providing the image data as input to a trained machine learning model; and
obtaining, from the trained machine learning model, output associated with predictive data associated with the first pattern data.

11. A non-transitory machine-readable storage medium storing instructions which, when executed, cause a processing device to perform operations comprising:
identifying first pattern data associated with a first substrate surface processed via a substrate processing system; and
causing, based on the first pattern data, a first subset of a plurality of portions of an optical modulator positioned at a pupil plane of an optical system to be in a first configuration to provide first portions of light reflected from the first substrate surface to an image detector and a second subset of the plurality of portions to be in a second configuration to prevent second portions of light reflected from the first substrate surface from contacting the image detector, wherein performance of a corrective action associated with the substrate processing system is to be based on the first portions of light provided through the first subset.

12. The non-transitory machine-readable storage medium of claim 11, the operations further comprising:
determining image data based on the first portion of light provided through the first subset; and
causing, based on the image data, the performance of the corrective action associated with the substrate processing system.

13. The non-transitory machine-readable storage medium of claim 11, the operations further comprising:
identifying second pattern data associated with a second substrate surface processed via the substrate processing system; and
causing, based on the second pattern data, a third subset of the plurality of portions to be in the first configuration to provide third portions of light reflected from the second substrate surface to the image detector and a fourth subset of the plurality of portions to be in the second configuration to prevent fourth portions of light reflected from the second substrate surface from contacting the image detector, and wherein the third subset are in the first configuration and the fourth subset are in the second configuration within about 0.5 ms to about 100 ms of the first subset being in the first configuration and the second subset being in the second configuration.

14. The non-transitory machine-readable storage medium of claim 11, wherein:
the optical modulator is a MEMS DMD;
each of the plurality of portions of the optical modulator comprises a corresponding micromirror of the MEMS DMD;
the first configuration corresponds to a first micromirror angle that causes the first portions of light to be directed to the image detector; and
the second configuration corresponds to a second micromirror angle that causes the second portions of light to be directed to one or more locations different than the image detector.

15. The non-transitory machine-readable storage medium of claim 11, wherein:
the optical modulator is an LCD;
each of the plurality of portions of the optical modulator comprises a corresponding pixel of the LCD;
the first configuration corresponds to a first pixel configuration that allows light transmission via the corresponding pixel; and
the second configuration corresponds to a second pixel configuration that prevents the light transmission via the corresponding pixel.

16. A system comprising:
a memory; and
a processing device coupled to the memory, the processing device to:
identify first pattern data associated with a first substrate surface processed via a substrate processing system; and
cause, based on the first pattern data, a first subset of a plurality of portions of an optical modulator positioned at a pupil plane of an optical system to be in a first configuration to provide first portions of light reflected from the first substrate surface to an image detector and a second subset of the plurality of portions to be in a second configuration to prevent second portions of light reflected from the first substrate surface from contacting the image detector, wherein performance of a corrective action associated with the substrate processing system is to be based on the first portions of light provided through the first subset.

17. The system of claim 16, wherein the processing device is further to:
determine image data based on the first portions of light provided through the first subset; and
cause, based on the image data, the performance of the corrective action associated with the substrate processing system.

18. The system of claim 16, wherein the processing device is further to:
identify second pattern data associated with a second substrate surface processed via the substrate processing system; and
cause, based on the second pattern data, a third subset of the plurality of portions to be in the first configuration to provide third portions of light reflected from the second substrate surface to the image detector and a fourth subset of the plurality of portions to be in the second configuration to prevent fourth portions of light reflected from the second substrate surface from contacting the image detector, and wherein the third subset are in the first configuration and the fourth subset are in the second configuration within about 0.5 ms to about 100 ms of the first subset being in the first configuration and the second subset being in the second configuration.

19. The system of claim 16, wherein:
the optical modulator is a MEMS DMD;
each of the plurality of portions of the optical modulator comprises a corresponding micromirror of the MEMS DMD;
the first configuration corresponds to a first micromirror angle that causes the first portions of light to be directed to the image detector; and
the second configuration corresponds to a second micromirror angle that causes the second portions of light to be directed to one or more locations different than the image detector.

20. The system of claim 16, wherein:
the optical modulator is an LCD;
each of the plurality of portions of the optical modulator comprises a corresponding pixel of the LCD;
the first configuration corresponds to a first pixel configuration that allows light transmission via the corresponding pixel; and
the second configuration corresponds to a second pixel configuration that prevents the light transmission via the corresponding pixel.
